(19) United States
(12) Patent Application Publication
(10) Pub. No.: US 2005/0223295 A1
(43) Pub. Date: Oct. 6, 2005

(54) Method for the creation of sequences for testing software

(75) Inventors: Thomas Hermes, Gifhorn (DE); Axel Schultze, Leiferde (DE)

Correspondence Address: WILLIAM COLLARD;COLLARD & ROE, P.C., 1077 NORTHERN BOULEVARD, ROSLYN, NY, 11576, US

(73) Assignee: IAV GmbH Ingenieurgesellschaft Auto und Verkehr

(21) Appl. No.: 11/086,549

(22) Filed: Mar. 22, 2005

(30) Foreign Application Priority Data
Mar. 24, 2004 (DE) 10 2004 014 290.4

(51) Int. Cl. G06F 11/00

(52) U.S. Cl. 714/38

(57) ABSTRACT

A method is provided for creating sequences for testing software created from data flow models and subjected to automatic test conditions by a data processing device and an executable test case generator software, whereby a test plan made up of individual test cases is generated by the test case generator software for the software to be tested. For each model block, test-relevant algorithms are implemented the form of a test case algorithm and a backward follow-up algorithm. In each test case, a value range for each of its input signals is assigned to a model block, by the test case algorithm. Each of such value ranges is followed up by means of the backward follow-up algorithm, in the system to be tested, through the individual blocks, up to the inputs of the system to be tested, and the results are checked and stored in memory.

### CROSS REFERENCE TO RELATED APPLICATIONS

Applicants claim priority under 35 U.S.C. §119 of German Application No. 10 2004 014 290.4 filed Mar. 24, 2004.

### BACKGROUND OF THE INVENTION

1. Field of the Invention

The present invention relates to a method for the creation of sequences for testing software. Specifically, the present invention relates to a method for creating sequences for testing software which was created from data flow models and which is subjected to automatic test conditions by means of a data processing device and an executable test case generator software, whereby a test plan made up of individual cases is generated by the test case generator software for the software to be tested.

2. The Prior Art

In many cases, particularly in the automotive industry, software is currently developed from data flow models or from a combination of data flow models and status diagrams. In other words, the software is developed from a graphic representation that is generated in tools such as “Simulink” and/or “Stateflow,” “ASCET” or “Matrix X.” They are similar to wiring diagrams in electrical technology and consist of individual “blocks” whose inputs and outputs are connected by means of lines (“signals”). Using the functions defined in these models, the actual code can then be generated, in most cases in the C programming language. The actual code may be generated either manually by the programmer or also automatically by means of a so-called code generator. In the further progression of the software development process, this software then has to be tested on the target system (e.g. a control device). These tests are frequently performed in automated manner, using HIL (hardware-in-the-loop) test stations.

The creation of test plans is an essential component of professional software development. A disadvantage in this connection is that the precise sequence of the tests generally has to be determined by the tester, manually, usually in that the HIL test stations are controlled by way of simple programs (“scripts”). Such scripts consist of individual test cases, i.e. input values and (reference) output values, or sequences of such values. The actual test then consists of implementing the predetermined input values (or sequences of such values), in that they are predetermined by way of suitable interfaces in the target system. The output values of the target systems (or sequences of output values) are then also read out by way of suitable interfaces. These output values are then compared with the predetermined reference output values. If the real output values and reference output values agree within defined limits, the test has been passed. If the test is passed for all the test cases, and if the number of test cases is sufficient, the software has met the prerequisites of the model.

The expenditure for manual creation of the test plans and for running them can amount to up to 50% of the costs and the time expenditure that are required for the development of the software. In addition, if the test plans are created manually, a relatively high error risk results for several reasons. For one thing, often no clear standards are used to create the tests. As a result, the content of test plans is greatly dependent on the personal experience and the knowledge of the person drawing them up. For another thing, mistakes also cannot be precluded. Furthermore, experience has shown that the software quality increases with the number of useful, non-redundant test cases that have been performed. In practice, however, the application of this principle rather quickly finds its limits in the effort and expenditure required for such quality. Therefore an improvement of the software quality can also be achieved by means of an automated test case generation, because of the reduced expenditure for test plan creation.

A method for the model-based generation of test scenarios is previously known from DE 100 55 679 A1. In this method, a classification tree is automatically generated from at least a part of a simulation model that is present in program form, whereby test-relevant data are automatically extracted from the simulation model, using a model extractor. The test-relevant data are represented as tree components and brought together to form a classification tree. In the case of model-based testing, the test scenarios are automatically derived from a specification that can be implemented, for example in the form of a Matlab/Simulink model. Using these test scenarios, not only can the model itself be tested in the model test, but also the software developed from it can be tested in the software test.

By means of this method, the expenditure for the creation of the test cases is simplified by means of partial automation. However, the storage of test-relevant data in tree structures is a disadvantage, because it results in great demands on the available memory space of the computer system being used.

A method for the automatic testing of software, using a data processing device and executable test case generator software is previously known from DE 102 18 212 A1. With this method, the dynamic and semantic behavior of the user interface of the software is specified with a graphic editor. Using the specified behavior of the user interface, the test case generator software generates test cases that are carried out by software for automatic testing, either directly afterwards or in a separate step.

The method presented in DE 102 18 212 A1 is limited to the generation of test data for graphical operating elements whose behavior is described in the form of status diagrams. In contrast, the generation of test cases for other types of systems, or for systems that are described by data flow models, is not described.

### SUMMARY OF THE INVENTION

The present invention aims at providing a method for the creation of sequences for testing software, with which the expenditure for drawing up test plans to be carried out, and the computer time for checking the program, are reduced, while at the same time reducing the error rate.

According to one aspect of the invention, this object is accomplished by means of a method for the creation of sequences for testing software, which was created from data flow models and which is subjected to automatic test conditions by means of a data processing device and an executable test case generator software, whereby a test plan is generated by the test case generator software for the software to be tested, the plan being made up of individual cases, wherein for each model block, test-relevant algorithms are implemented in the form of a test case algorithm and a backward follow-up algorithm; in each test case, a value range for each of its input signals is assigned to a model block, by the test case algorithm; and each of such value ranges is followed up by means of the backward follow-up algorithm, in the system to be tested through the individual blocks, up to the inputs of the system to be tested, and the results are checked and stored in memory.

Test-relevant algorithms in the form of a test case algorithm, a pass-through algorithm, a backward follow-up algorithm and a forward follow-up algorithm are implemented for every model block, in a test case of the software. Because these test-relevant algorithms are implemented for every model block, the partial amount, predetermined for a model block, of a possible value range of the input signals in question is followed up by the other models blocks, up to their inputs and outputs, and it is checked whether a practical link of the individual blocks is present.

By means of the forward and backward follow-up of the input value range in the preceding and subsequent model blocks, values are possible at the same time are followed up further, up to the system inputs and outputs of the system being tested. In that value ranges and not individual values are followed up, the likelihood that backward follow-up will be successful, i.e. that input value ranges are found for every block that was traversed, increases, so that any desired input values from these ranges will result in an output value from the predetermined output value range, in each instance. Furthermore, in the case of backward follow-up, it is possible to avoid backtracking (i.e. partial repetition of the backward follow-up) because of different requirements for the same signal, in many cases. As a result, the computer time is decreased, as compared with the method described in the state of the art. Furthermore, because of the partially automatic generation of the test plans, the error rate during testing of the software is reduced. The error rate reduction results from the adherence to standards being forced by means of the use of predetermined algorithms, because these standards are established by these algorithms. Another advantage of the method according to the invention is that the manual effort for the creation of test plans is reduced by means of the implementation of the test-relevant algorithms for every model block.

Possible value ranges for the inputs of a block may be determined by means of the backward follow-up algorithm, from predetermined value ranges for the outputs of the block, so that for every possible combination of values from the calculated input value ranges, output values are obtained that lie within the predetermined value ranges.

In the case of branching of a signal, when using the backward follow-up algorithm, the value range restrictions of all the block inputs connected to the branching may be taken into consideration, at the same time, by forming an intersection amount which is then set as the output value range of a block output connected to the branching.

A concrete value may be selected from the calculated value ranges for the system inputs, in each instance, so that the totality of these concrete values forms an input vector for the test case, in each instance.

For every model block, a test-relevant algorithm in the form of a forward follow-up algorithm may be implemented, in addition, and every value range generated by the test case algorithm may be followed up by means of the forward/follow-up algorithm, in the system to be tested, through the individual block up to the outputs of the system to be tested, and the results may be stored in memory.

For eery model block, a test-relevant algorithm in the form of a pass-through algorithm may be implemented, in addition, and input values for the blocks directly or indirectly connected to the output of a block to be tested may be determined, by means of the pass-through algorithm, so that the output value of the block is clearly dependent on a specific input value of the block, and the results may be stored in memory.

In the case of status dependent blocks, the value range of the signal may be replaced by a time sequence of such value ranges, whereby a corresponding time range is assigned to every value range.

In the case of status dependent blocks, the time progression of the value ranges, in each instance, may be taken into consideration by the test case algorithm, the pass-through algorithm, the backward follow-up algorithm, and by the forward follow-up algorithm.

The functions of the software may be tested in a target system, using the test cases determined, against the method of functioning represented in the model by means of individual blocks, individual test systems, or the overall system of the software.

To reduce the total number of test cases, the test cases determined may be brought together by means of an optimization algorithm.

Additional advantageous embodiments are described and explained below, together with their effects.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings:

FIG. 1 is a schematic representation of an exemplary model for testing software, and

FIG. 2 is a schematic representation of an exemplary model for testing software, having a hysteresis process.

### DETAILED DESCRIPTION OF PREFERRED EMBODIMENTS

Testing of software created from data flow models takes place by means of a data processing device and executable test case generator software. By means of the test case generator software, a test plan, which is made up of individual test cases, is generated for the software to be tested. The automatic, model-based test case generation proceeds from the assumption that the behavior of each model block is completely known. Based on this assumption, the output value of a block can be calculated if the input values are known. For status-dependent block types, in order to calculate the output values, partial or complete knowledge of the previous progression of the input values is necessary, in addition, depending on the block type. This requirement relates, for example, to delay elements, integrators, or the like.

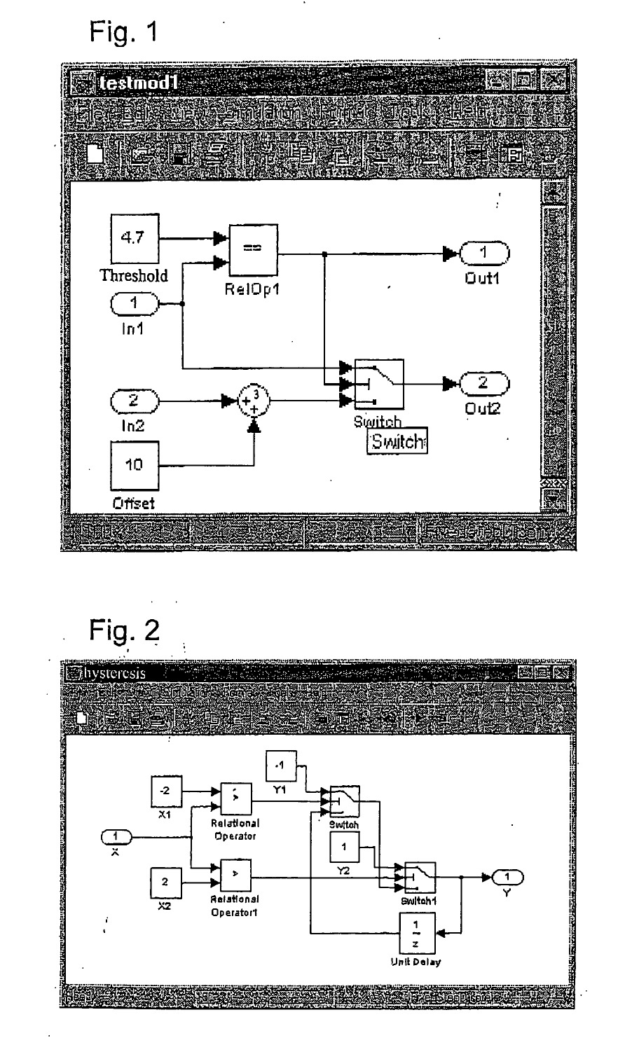

According to the invention, test-relevant algorithms in the form of a test case algorithm, a pass-through algorithm, a backward follow-up algorithm, and a forward follow-up algorithm are implemented for every model block, in order to test software. In each test case, a possible value range for every input signal is assigned to a model block, for each test case, by the test case algorithm. The input value range is followed up, by means of the forward follow-up algorithm and the backward follow-up algorithm, in the system to be tested, through the individual blocks, up to the inputs and outputs of the system to be tested, and the results are checked and stored. FIG. 1 schematically shows a test model for testing an exemplary model of a software.

The pass-through algorithm serves to pass a specific input value through to an output of the block, without any significant restriction of the value range and the precision. In other words, while the value is allowed to be changed in the block being considered, there must be a clear coordination between the input value and output value being considered. The pass-through algorithm checks whether this coordination is even possible, and establishes the other inputs of the block being considered in a suitable manner, if necessary.

The backward follow-up algorithm serves to convert value range restrictions for the outputs of a block into restrictions for its inputs. The algorithm assigns a certain value range to each input. Assigning a value from these ranges to each input, in each instance, assures that the output value will lie within the predetermined output value range. Because there are generally several possibilities for implementing these input value ranges in the case of a fixed output value range, this algorithm can also produce several results. For these results, an attempt is made, one after the other, to follow the value ranges up by way of the outputs of other blocks that are connected to the inputs.

The forward follow-up algorithm calculates a value range for every output of a block, for the input value ranges of that block. This calculation is done in that the output value lies within the output value range in every case, if the input values lie within the given input value ranges. If the input value ranges contain only one concrete value, in each instance, the algorithm also calculates the output value range with only one concrete value.

The exemplary model shown in FIG. 1 performs the following functions:

If the input signal “ln1” of the block “RelOp1” to be tested is equal to a value of 4.7, the value 1 is assigned to the output signal “Out1” and the value of the signal “ln1” is assigned to the signal “Out2”. If, on the other hand, “ln1” is not equal to the value of 4.7, the value 0 is assigned to the output signal “Out1” and the sum of the values of “ln2” and “Offset10” is assigned to the signal “Out2”. In this connection, all the switches “Switch” being used here are set to a threshold value of 0.5, Therefore, if the center input has the value 1 and is therefore true, the switch has the upper position shown, while with the value 0, which corresponds to false, the switch has the other position, in each instance. In other words, in the case of a false value, “Switch” would be in the lower position.

The purpose of the test case generator now is to find test cases with which the agreement of the function represented in the model with a given software in the target system (e.g. control device) that is supposed to fulfill the same function can be checked. For this purpose, it is necessary to find the functionality in the target system that is represented by every block in the model as clearly as possible.

For each block of the model, the following steps are therefore performed:

The system outputs must be dependent on the outputs of the block to be tested, with sufficient accuracy. Accordingly, for a test of the sum block (3), for example, “ln1” must have a value not equal to 4.7, so that at least one system output becomes dependent on the output of the sum block. The value of “ln2”, on the other hand, does not 54matter in this step. These restrictions for the system inputs are calculated in that the output being considered is followed up to the system outputs. For every block that is passed in this connection, a pass-through algorithm that is specific to that block is calculated, as to whether and how the value can be passed on to the output of the block being passed, without any losses in resolution and value range, if possible. In the case of the switch, such passing happens, in the example being shown, by applying a “0” to the control input. If there is no suitable possibility, test case generation for the sum block would not make sense, because it would not be possible to check the output of the block with sufficient accuracy. For each of the blocks that is passed, restrictions for the possible value ranges of the block inputs are generated with this method. By means of the backward follow-up algorithm, these restrictions are followed up all the way to the system inputs.

For every block type, a number of test cases is predetermined by means of a test case algorithm. As a result, for every test case, a value range is assigned to every input signal of the block in question, from which concrete values for the test case in question can be selected. Afterwards, the selected value ranges for the input signals of the block are followed up to the system inputs of the system to be tested, using the “backward follow-up algorithm.” In this connection, any possible restrictions of the value ranges of signals, which were set in the previous step on the basis of the pass-through algorithm, are taken into consideration. In the case of both steps, the result can be that the test case cannot be implemented. In the previous step (pass-through algorithm), it could turn out that tests cannot be implemented for a block in general, because the block outputs cannot be observed with sufficient accuracy and therefore later, during the test, the agreement of the reference values with the actual values cannot be assessed. In the case of the backward follow-up, it can turn out that individual test cases cannot be followed up back to the inputs of the system. This inability can be due both to the logical impossibility of specific cases, because of the signal linking in the model, or to the insufficiency of the backward follow-up algorithm. In general, the backward follow-up algorithm cannot try out all the possible cases for backward follow-up of value ranges, because computer time is limited in practical situations.

The result of the backward follow-up of test cases to the system inputs is a value range per input signal, in each instance, for all the input signals on which the block being tested depends. In order to be able to perform concrete tests, a concrete value is selected from these value ranges, in each instance. In the case of additional input signals on which the block to be tested does not depend, any desired values can be selected. By way of the forward follow-up algorithm, the actual input values of the block to be tested can then be calculated from the selected system input values. From these values, reference output values of the block are calculated, and finally, the reference output values of the system are also calculated.

If one passes by a branching during the course of the backward follow-up for example between “ln1” and “RelOP1” or “Switch” value ranges of two inputs must be taken into consideration at the same time. These value ranges are taken into consideration in that the intersection amount of the two value ranges is formed. If, during the backward follow-up, one arrives at a system input—“ln1” or “ln2” in the example—the value range followed back to there is stored in memory. When this process has been done for all the system inputs that influence the block originally being considered, the backward follow-up has been completed.

If, at any time during the backward follow-up, an empty amount results as the value range, the backward follow-up has been terminated without success. In that case, a different -9.M i. 2005 implementation possibility for the input value ranges has to be tried out, possibly in one of the blocks that was previously passed. If all implementation possibilities have been exhausted for all blocks that have been passed, and still no solution was found, the original value in question cannot be followed back to the system inputs.

The above considerations were carried out for status-independent blocks. Status-dependent blocks are those blocks in which the output values are also dependent on the input values of preceding calculation cycles. Examples for status-dependent blocks are delay elements (“1/z”), integrators, differentiators, transmission functions, hysteresis blocks, regulators, filters, and blocks that contain status machines (e.g. stateflow diagrams).

In contrast to status-independent blocks, in the case of status-dependent blocks it is not the individual values of the input signals that are important, but rather the progression of these input signals in the past. For the test case generation, the individual signals therefore have sequences of value ranges (“sequences”) assigned to them in place of individual value ranges.

Each value range within a sequence also has a time range assigned to it, indicating the number of calculation cycles for which the value range in question is valid. By way of the cycle time (e.g. 10 ms, 20 ms, 100 ms, etc.), the corresponding time in seconds can be calculated. Time ranges can contain only positive whole numbers.

FIG. 2 shows a status-dependent system using the T example of a hysteresis function. If, in this connection, the value “X” is greater than the value of the constant “X2”, the output “Y” will contain the value of the constant “Y2”. Otherwise, “Y” contains the value of “Y1” if “X” is less than “X1”. If “X” lies between “X1” and “X2”, “Y” remains unchanged at the same value as during the previous calculation cycle. The deciding factor here is the use of the “1/z” block. The output of this block results in the value of “Y” in the last time slice, in each instance, and makes the entire system status-dependent.

The actual test case generation for status-dependent blocks then proceeds analogous to the test case generation for status-independent blocks, whereby value ranges must be replaced with sequences, in each instance. In the case of the three partial algorithms, this process results in additional points that must be taken into consideration:

In comparison with status-independent blocks, an additional deciding factor in the case of status-dependent blocks is to pass the time progression of the signal to be followed up at the output on to the output of the block in unchanged manner, if possible. A constant time shift of the input signal would not be a problem in this connection. In the case of the “1/z” block used in the example shown, a constant time shift would not be a problem; it merely results in a constant delay by one time slice. Therefore all the values of “Y” would be passed on unchanged, but delayed.

In the case of the backward follow-up algorithm, a time progression of the input value ranges has to be taken into consideration in addition to the value ranges of the output signal, which are attributable to value range restrictions of the input signals. Here again, there can be variation possibilities for the input sequences, which result in the same output sequences. Accordingly, several possibilities and their further backward follow-up must be tried out.

In the case of forward follow-up of sequences through a block, as well, the forward follow-up algorithm must ensure that at the outputs, a sequence of values that is contained in the calculated output sequence is obtained for every sequence of values contained in the input sequences.

To reduce the total number of test cases, the test cases determined can be brought together using an optimization algorithm. In this way, the computer time for checking the program is also reduced.

Although only a few embodiments of the present invention have been shown and described, it is to be understood that many changes and modifications may be made thereunto without departing from the spirit and scope of the invention as defined in the appended claims.

1. A method of creating sequences for testing software created from data flow models and subjected to automatic test conditions by a data processing device and an executable test case generator software to generate a test plan for the software to be tested comprising individual test cases, said method comprising the steps of:
(a) implementing for each model block test-relevant algorithms comprising a test case algorithm and a backward follow-up algorithm;
(b) assigning in each test case a value range for each input signal of the test case to a model block via the test case algorithm;
(c) following up each value range via the backward follow-up algorithm in a system to be tested through individual model blocks up to inputs of the system to be tested to arrive at results;
(d) checking the results; and
(e) storing the results in a memory.

2. The method as recited in claim 1, wherein possible input value ranges for inputs of a model block are calculated by the backward follow-up algorithm, from predetermined value ranges for outputs of the model block, so that for every possible combination of values from the possible input value ranges, so calculated, output values are obtained that lie within the predetermined value ranges.

3. The method as recited in claim 1, wherein in the case of branching of a signal, when using the backward follow-up algorithm, value range restrictions of all block inputs connected to the branching are taken into consideration, at the same time, by forming an intersection amount which is then set as an output value range of a block output connected to the branching.

4. The method as recited in claim 1, wherein a respective specific value is selected from calculated value ranges for each input of the system, so that the specific values combine to form an input vector for the test case, in each instance.

5. The method as recited in claim 1, further comprising the steps of:
(a) implementing for every model block a test-relevant algorithm comprising a forward follow-up algorithm; and
(b) following up every value range generated by the test case algorithm by the forward follow-up algorithm, in the system to be tested, through the individual model block up to outputs of the system to be tested to arrive at results, and storing the results in the memory.

6. The method as recited in claim 5, further comprising the steps of:
(a) implementing for every model block a test-relevant algorithm comprising a pass-through algorithm; and
(b) determining input values for the model blocks directly or indirectly connected to an output of a model block to be tested by the pass-through algorithm, so that an output value of the model block is clearly dependent on a specific input value of the model block, and storing the input values in the memory.

7. The method as recited in claim 6, wherein in the case of status-dependent blocks, the value range of a signal is replaced by a time sequence of value ranges, whereby a corresponding time range is assigned to each value range.

8. The method as recited in claim 7, wherein in the case of status-dependent blocks, a respective time progression of each value range is taken into consideration by the test case algorithm, the pass-through algorithm, the backward follow-up algorithm, and the forward follow-up algorithm.

9. The method as recited in claim 1, wherein functions of the software are tested in a target system, using the test cases determined, against a method of functioning represented in a model by the individual model blocks, by individual test systems, or by an overall system of the software.

10. The method as recited in claim 1, wherein to reduce in number the test cases in the test plan, the test cases determined are brought together by means of an optimization algorithm.
